(19) United States
(12) Patent Application Publication
(10) Pub. No.: US 2012/0203541 A1
(43) Pub. Date: Aug. 9, 2012

(54) GENERATING INPUT SUGGESTIONS

(75) Inventors: Xun Liu, Sunnyvale, CA (US); Guangqiang Zhang, Beijing (CN); Yufan Zhu, Sunnyvale, CA (US); Zhengzhu Feng, Sunnyvale, CA (US)

(73) Assignee: GOOGLE INC., Mountain View, CA (US)

(21) Appl. No.: 13/143,069

(22) PCT Filed: Nov. 25, 2009
(86) PCT No.: PCT/CN2009/001317

§ 371 Date: Jun. 30, 2011

(30) Foreign Application Priority Data
Oct. 29, 2009 (CN) PCT/CN2009/001205

(51) Int. Cl. G06F 17/21

(52) U.S. Cl. 704/8

(57) ABSTRACT

Methods, systems, and apparatus, including computer program products, for generating input suggestions, e.g., from textual input that is represented in different input forms. A method includes receiving a textual input entered in an input field by a user, the textual input including a first n-gram in a first form of representing a first language and at least one of: a second n-gram in a second form of representing the first language, and a third n-gram in a second language; generating one or more alternative representations, in an ambiguous form, of the textual input; sending the alternative representations to a suggestion service and receiving from the suggestion service one or more input suggestions; and comparing the one or more input suggestions to the textual input to identify a group of the one or more input suggestions as being selectable alternatives to the textual input for display in a user interface.

### BACKGROUND

This specification relates to digital data processing, and in particular, to computer-implemented search services.

Conventional search services provide search query suggestions as alternatives to input search queries. For example, a conventional search engine can include a query input field that receives a textual input. In response to receiving the textual input, a conventional search service can provide search query suggestions for the textual input. A user can select a search query suggestion for use as a search query.

In some situations, a user may provide textual input that is represented in different input forms. For example, the textual input can include a mix of morphemes in a first script (e.g., Hanzi characters), lexical items in a second script (e.g., English words), and graphemes in the second script that represent phonetic representations of morphemes in the first script (e.g., Pinyin syllables, or Pinyin abbreviations).

### SUMMARY

This specification describes technologies relating to generation of search query suggestions.

In general, one aspect of the subject matter described in this specification can be embodied in methods that include the actions of receiving a textual input entered in an input field by a user, the textual input including a first n-gram in a first form of representing a first language and at least one of: a second n-gram in a second form of representing the first language; and a third n-gram in a second language; generating one or more alternative representations of the textual input, where the alternative representations are in an ambiguous form that represents one or more input suggestions that do not directly match the textual input; sending the alternative representations to a suggestion service and receiving from the suggestion service one or more input suggestions; and comparing the one or more input suggestions to the textual input to identify a group of the one or more input suggestions as being selectable alternatives to the textual input for display in a user interface. Other embodiments of this aspect include corresponding systems, apparatus, and computer program products.

These and other embodiments can optionally include one or more of the following features. Generating one or more alternative representations of the textual input in an ambiguous form includes: segmenting the textual input into one or more contiguous sequences of characters, where each sequence represents a word or query; identifying one or more representations of each segment, where each representation is in an alternative form; and replacing, in the textual input, one or more segments with an associated representation in an alternative form to produce an alternative representation of the textual input.

The textual input includes a second n-gram in a second form of representing the first language, and generating one or more alternative representations of the textual input in the ambiguous form includes: generating a fourth n-gram from the textual input, where the fourth n-gram is an alternative representation of the textual input and includes one or more sequences of text in the second form. The fourth n-gram includes one or more sequences of text in the first form.

The second form of representing the first language includes representing the first language using complete phonetic representations or partial phonetic representations. The first language is Chinese, and the first form of representing Chinese includes representing Chinese using Hanzi characters. A complete phonetic representation is a Pinyin syllable, and a partial phonetic representation is a Pinyin abbreviation. The textual input includes a third n-gram in a second language and the second language is English. The selectable alternatives include one or more input suggestions that are represented using Hanzi characters. The textual input is received before the user submits the textual input in a request for a search and after waiting a predetermined amount of time after receiving each token of the textual input.

Particular embodiments of the subject matter described in this specification can be implemented to realize one or more of the following advantages. Automatically generating input suggestions from textual input represented in different input forms reduces how much user interaction is required to obtain search suggestions. In addition, obtaining search suggestions for textual input represented in different forms can increase the coverage of searches by capturing search query suggestions that may not be convenient for a user to provide, e.g., the user may not have access to an input method editor (IME) or may not know how to provide textual input in a particular script of a language.

Generating alternative representations, in an ambiguous form, of the textual input for use in determining the input suggestions reduces how much memory is required to store possible representations of a textual input. In addition to reducing memory usage, generating alternative representations in an ambiguous form increases the precision, recall, and efficiency of identifying input suggestions (e.g., transliterations) by increasing the coverage of searches and reducing the number of input suggestions that are processed.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example of a flow of data in some implementations of a system that generates selectable alternatives textual input in different forms.

FIG. 2 is a block diagram illustrating an example input suggestion aggregator.

FIG. 3 is a diagram illustrating an example textual input and an example selectable alternative for the textual input.

FIG. 4 is a block diagram illustrating an example of a flow of data showing how input suggestions are generated from a particular textual input.

FIG. 5 is a flow chart showing an example process for automatically generating selectable alternatives of textual input in different forms.

Like reference numbers and designations in the various drawings indicate like elements.

### DETAILED DESCRIPTION

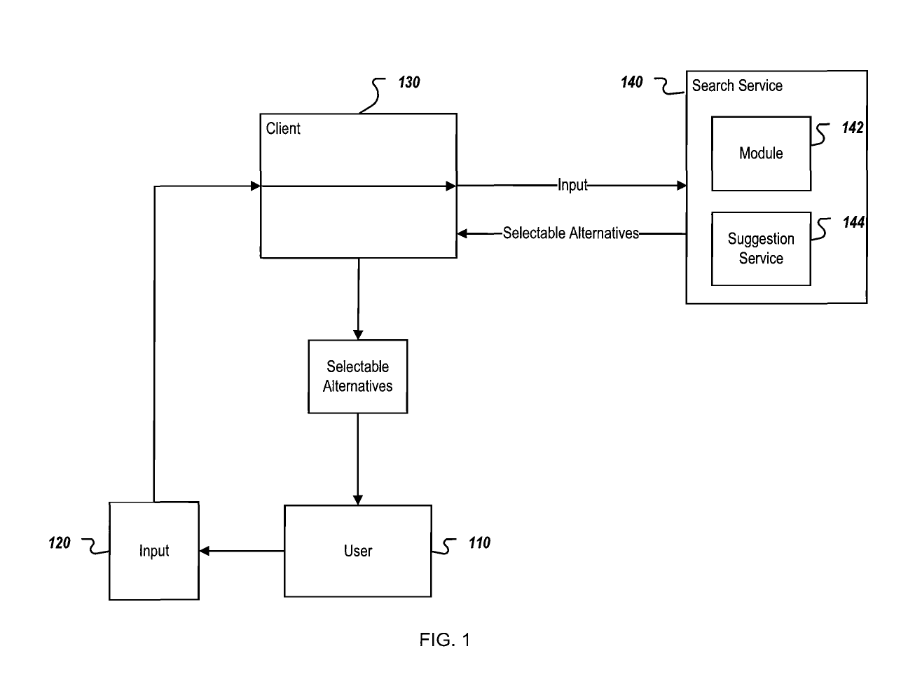

FIG. 1 is a block diagram illustrating an example of a flow of data in some implementations of a system that generates selectable alternatives textual input in different forms. A user 110 provides input 120 to a search engine query input field presented by a client 130. The input 120 includes n-grams in different forms.

An n-gram is a sequence of n consecutive tokens, e.g., characters or words. An n-gram has an order, which is a number of tokens in the n-gram. For example, a 1-gram (or unigram) includes one token; a 2-gram (or bi-gram) includes two tokens. The input 120 can include a first n-gram in a first form of representing a first language. The input 120 can also include a second n-gram in a second form of representing the first language, or a third n-gram in a second language.

As an example, “ [symbol] ” (e.g., “me” in English and pronounced “w\check{o}”) can be a first n-gram in a first form of representing a first language, e.g., a Hanzi character for representing Chinese. In addition, “wo” can be a second n-gram in a second form of representing the first language. In particular, “wo” is a 2-gram that is a complete phonetic representation (e.g., a Pinyin syllable) of “ [symbol] ”. Furthermore, “w” is another example of a second n-gram in a second form of representing the first language. In particular, “w” is a 1-gram that is a partial phonetic representation of multiple Hanzi characters, e.g., a Pinyin abbreviation of “ [symbol] ” pronounced “w\check{o}”, “ [symbol] ” pronounced “wò”, and “ [symbol] ” pronounced “weì”. The Roman character “w” is referred to as a partial phonetic representation because it is the first character in the sequence of characters in a Pinyin syllable.

The client 130 sends to a search service 140 a request for selectable alternatives of the input 120. The request includes the input 120. In some implementations, the client 130 sends the request immediately after each token of a textual input, e.g., after each character of a first search query or each word of a first search query, is received at the search engine query input field. As a result, selectable alternatives can be provided to the user as the user types each token of the textual input. In some alternative implementations, the client 130 implements a delay, waiting a predetermined amount of time before automatically making the request to the search service 140.

A module 142, e.g., a software script, installed on the search service 140 receives the input 120. The module 142 processes the input 120 to transform the input 120 into an ambiguous form. In particular, the module 142 generates one or more alternative representations of the input 120 that are each in an ambiguous form, as will be described in further detail below. The module 142 sends the alternative representations to a suggestion service 144 that is installed on the search service 140. In some alternative implementations, the search service 140 is installed on an intermediate server and the suggestion service 144 is installed on a receiving server that receives the alternative representations from the search service 140.

The suggestion service 144 returns one or more input suggestions for the input 120. The input suggestions are alternatives to the input 120, e.g., completions, transliterations. The module 142 compares the one or more input suggestions to the input 120 to identify a group of the one or more input suggestions as being selectable alternatives to the input 120. The module 142 returns the selectable alternatives to the client 130, in real time, i.e., as the user 122 is typing characters in the search engine query input field, for display in a user interface.

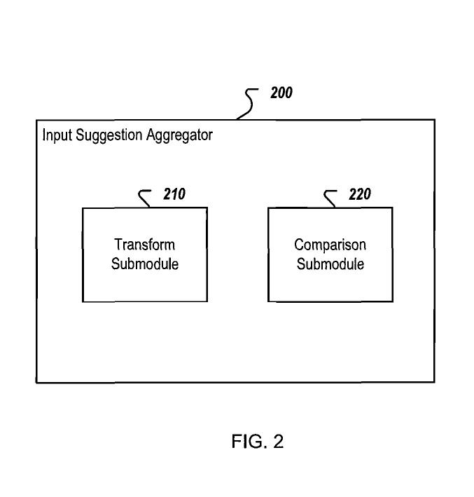

FIG. 2 is a block diagram illustrating an example input suggestion aggregator 200. The input suggestion aggregator 200 includes a transformation submodule 210 and a comparison submodule 220. The input suggestion aggregator 200 receives a textual input. The transformation submodule 210 generates one or more alternative representations, in an ambiguous form, of the textual input. The comparison submodule 220 receives the input suggestions, and compares the input suggestions to the textual input to identify a group of the one or more input suggestions as being selectable alternatives to the first textual input.

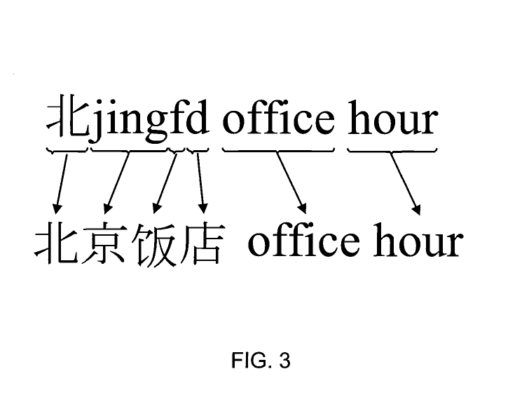

FIG. 3 is a diagram illustrating an example textual input and an example selectable alternative for the textual input. The textual input includes the sequence of characters “ [symbol] jingfd office hour”, which represent multiple n-grams in different forms. In particular, the textual input includes a 1-gram in a first form of representing a first language, i.e., a Hanzi character “ [symbol] ”. The textual input also includes a 4-gram in a second form of representing the first language, i.e., a complete phonetic representation “jīng” (a Pinyin syllable). In addition, the textual input includes two 1-grams in a third form of representing the first language, i.e., a Pinyin abbreviation “f”, and a Pinyin abbreviation “d”. The textual input also includes a 6-gram and a 4-gram in a different second language, i.e., the English words “office” and “hour”.

The selectable alternative includes the Hanzi characters “ [symbol] ”, “ [symbol] ”, “ [symbol] ”, and “ [symbol] ”. The selectable alternative also includes the English words “office” and “hour”. The Hanzi character “ [symbol] ” is represented by a same character in the textual input. The Hanzi character “ [symbol] ” (e.g., “capital” in English and pronounced “jīng”) is represented by the Pinyin syllable “jīng” in the textual input. The Hanzi character “ [symbol] ” (e.g., “food” in English and pronounced “fan”) is represented by the Pinyin abbreviation “f” in the textual input, and the Hanzi character “ [symbol] ” (e.g., “store” in English and pronounced “diàn”) is represented by the Pinyin abbreviation “d”. The English words “office” and “hour” are represented by the same words in the textual input. Example translations of the selectable alternative include “Beijing restaurant office hours” and “Beijing hotel office hours”, where “ [symbol] ” is translated as “Beijing” and “ [symbol] ” is translated as “restaurant” or “hotel”.

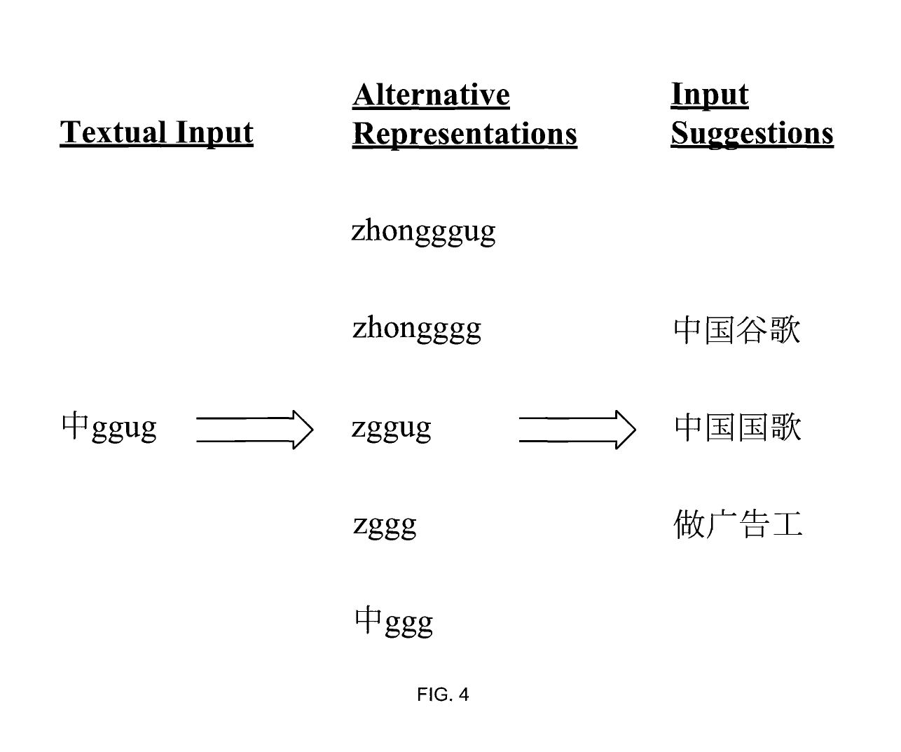

FIG. 4 is a block diagram illustrating an example of a flow of data showing how input suggestions are generated from a particular textual input. In the example, the textual input includes the sequence of characters “ [symbol] ggug”, where the Hanzi character “ [symbol] ” can be translated alone as “middle” in English and pronounced “zhōng”, or as “hit” in English and pronounced “zhòng”. The textual input includes a first 1-gram “ [symbol] ”, a second 1-gram “g”, a third 1-gram “gu”, and a fourth 1-gram “g”.

Generating alternative representations in an ambiguous form includes segmenting the textual input into one or more contiguous sequences of characters.

In some implementations, the segmenting is performed using prefix matching. The textual input is segmented into the contiguous sequences starting from a first character received as input from the user. Each sequence of characters, starting from the first sequence at the beginning of the order in which sequences were segmented and ending at the last sequence at the end of the order, consists of the longest sequence of characters that represents a word or query.

As an example, a user provides as textual input a first character “X₁”, followed by a second character “X₂”, followed by a third character “X₃”, and followed by a fourth character “X₄”. The textual input includes, from left to right, in the order in which each character was received, the characters “X₁ X₂ X₃ X₄”. If “X₁ X₂ X₃ X₄” represents a word, then the textual input is not segmented and only the contiguous sequence “X₁ X₂ X₃ X₄” is identified.

If “X₁ X₂ X₃ X₄” does not represent a word, then the transformation submodule 210 determines if “X₁ X₂ X₃” represents a word. If “X₁ X₂ X₃” represents a word, then the textual input is segmented into two contiguous sequences “X₁ X₂ X₃” and “X₄”.

If “X₁ X₂ X₃” does not represent a word, then the transformation submodule 210 determines if “X₁ X₂” represents a word. If “X₁ X₂” represents a word, then “Xᵢ X₂” is identified as a first contiguous sequence. Then, the transformation submodule 210 determines if “X₃ X₄” represents a word. If the sequence “X₃ X₄” represents a word, then the textual input is segmented into two contiguous sequences “X₁ X₂” and “X₃ X₄”.

If “X₁ X₂” does not represent a word, then “X₁” is identified as a first contiguous sequence. A similar process is used to identify a second contiguous sequence in “X₂ X₃ X₄”. In particular, if “X₂ X₃ X₄” represents a word, the textual input is segmented into the two contiguous sequences “X₁” and “X₂ X₃ X₄”. If “X₂ X₃ X₄” does not represent a word, the transformation submodule 210 determines if “X₂ X₃” represents a word. If “X₂ X₃” represents a word, the textual input is segmented into three contiguous sequences “X₁”, “X₂ X₃”, and “X₄”. If “X₂ X₃” does not represent a word, the textual input is segmented into four contiguous sequences “X₁”, “X₂”, “X₃”, and “X₄”.

In some alternative implementations, the segmenting is performed using midfix matching or postfix matching.

In FIG. 4, the sequence of characters “ [symbol] ggug” is segmented into four contiguous sequences. “ [symbol] ggug”, “ [symbol] ggu”, “ [symbol] gg”, and “ [symbol] g” each do not represent a word, so “ [symbol] ” is identified as a first contiguous sequence. “ggug”, “ggu”, and “gg” each do not represent a word, so “g” is identified as a second contiguous sequence. In particular, “g” can be a prefix for a word in English (e.g., “good”, “grain”), or a Pinyin abbreviation (e.g., for the Pinyin syllables “gu”, “ga”, “gai”).

“gug” does not represent a word, but “gu” can represent a word, so “gu” is identified as a third contiguous sequence. In particular, “gu” can represent a Pinyin syllable. Example Pinyin syllables that “gu” can represent include: “g\check{u}” (e.g., a phonetic representation of “ [symbol] ”, which means “share” in English), “gù” (e.g., a phonetic representation of “ [symbol] ”, which means “strong” in English), and “gū” (e.g., a phonetic representation of “ [symbol] ”, which means “lone” in English). Therefore, “gu” is identified as a third contiguous sequence and “g” (i.e., the last character received in “ [symbol] ggug”) is identified as fourth contiguous sequence. As a result, the textual input “ [symbol] ggug” is segmented into four contiguous sequences “ [symbol] ”, “g”, “gu”, and “g”.

Alternative representations, in generic forms, of the textual input are generated using the identified segments. In particular, representations in alternative forms of each segment are identified. In some implementations, each segment can be represented by a complete phonetic representation or a partial phonetic representation. In the example of FIG. 4, representations in alternative forms of “ [symbol] ” include “zhong” (i.e., a Pinyin syllable) and “z” (i.e., a Pinyin abbreviation). Representations in alternative forms of “gu” include “g” (i.e., a Pinyin abbreviation). In some implementations, representations in alternative forms of identified segments that consist of a single character are not identified. Returning to the example, representations, in alternative forms, of the second “g” and third “g” in the textual input are not identified.

Alternative representations of the textual input in an ambiguous form are generated from the identified segments and representations in alternative forms of the segments. In particular, the segments in the textual input can be replaced in different combinations to generate the alternative representations. In FIG. 4, examples of alternative representations include “zhongggug”, where “ [symbol] ” was replaced by “zhong”; “zhongggg”, where “ [symbol] ” was replaced by “zhong” and “gu” was replaced by “g”; “zggug”, where “ [symbol] ” was replaced by “z”; “zggg”, where “ [symbol] ” was replaced by “z” and “gu” was replaced by “g”; and “ [symbol] ggg”, where “gu” was replaced by “g”. FIG. 4 does not show all possible alternative representations in generic forms that are processed in practice.

The alternative representations can be referred to as being in an ambiguous form because the alternative representations can each represent one or more input suggestions.

Some of the one or more input suggestions do not directly match the textual input. In addition, some of the one or more input suggestions are different from input suggestions generated directly from the textual input. As an example, the alternative representation “zggg” includes Pinyin abbreviations “z”, “g”, “g”, and “g”. The first Pinyin abbreviation “z” in “zggg” can represent Pinyin syllables and Hanzi characters that do not correspond to “ [symbol] ” in the textual input. As an example, “z” can represent a Pinyin syllable “zi” that corresponds to the Hanzi characters “ [symbol] ” and “ [symbol] ”. In addition, the second “g” in “zggg” can represent Pinyin syllables and Hanzi characters that do not match “gu” in the textual input. As an example, “g” can represent a Pinyin syllable “gang” that corresponds to the Hanzi characters “ [symbol] ” and “ [symbol] ”.

The alternative representations are sent to a suggestion service. In some implementations, the textual input is also sent to the suggestion service. The suggestion service identifies one or more input suggestions using the alternative representations and returns the one or more input suggestions to the suggestion service. In FIG. 4, examples of input suggestions include “ [symbol] ” (e.g., “Google China” in English and pronounced “Zhōng guó G\check{u} gē”), “ [symbol] ” (e.g., “Chinese national anthem” in English and pronounced “Zhōng guó guó gē”), and “ [symbol] ” (e.g., “advertising industry” in English and pronounced “zuó gu\check{a}ng gào gōng”). FIG. 4 does not show all possible input suggestions that are processed in practice.

The comparison module 220 compares the input suggestions to the textual input to identify a group of the one or more input suggestions as being selectable alternatives to the first textual input. In particular, the comparison module 220 identifies input suggestions that are not likely to be represented by the textual input for exclusion from the group of the one or more input suggestions that are identified as being selectable alternatives to the first textual input. A phonetic representation of “ [symbol] ” is “zhong guo gu ge”, a phonetic representation of “ [symbol] ” is “zhong guo guo ge”, and a phonetic representation of “ [symbol] [symbol] ” is “zuo guang gao gong”, where diacritics have been removed.

Comparing “ [symbol] ” with “ [symbol] ggug”, the first segment “ [symbol] ” (“zhong”) in the textual input is less likely to represent “ [symbol] ” (“zuo”) than to represent “ [symbol] ” (“zhong”). In addition, comparing “ [symbol] ” with “ [symbol] ggug”, the third segment “gu” is less likely to represent “ [symbol] ” (“guo”) than to represent “ [symbol] ” (“gu”), i.e., an identical match.

In some implementations, only direct matches are identified as being selectable alternatives to the textual input. In the previous example, only “ [symbol] ” (“zhong guo gu ge”) is a direct match, because the Hanzi character “ [symbol] ” is a match of the Hanzi character “ [symbol] ”, the Pinyin syllable “guo” is a match of the Pinyin abbreviation “g”, the Pinyin syllable “gu” is a match of the Pinyin syllable “gu”, and the Pinyin syllable “ge” is a match of the Pinyin abbreviation “g”. In “ [symbol] ” (“zhong guo guo ge”), the Pinyin syllable “guo” is not a match of the Pinyin syllable “gu”. In addition, in “ [symbol] ” (“zuo guang gao gong”), the Hanzi character “ [symbol] ” is not a match of the Hanzi character “ [symbol] ”, and the Pinyin syllable “gao” is not a match of the Pinyin syllable “gu”. The selectable alternatives are returned to the client 130 for presentation to the user 110.

In some implementations, the selectable alternatives are ranked according to frequencies that unique users have entered each selectable alternative as a query for a search. In some implementations, the rankings are modified using edit distances. As an example, selectable alternatives “women clothing” and “ [symbol] ” (e.g., “we” in English and pronounced “w\check{o}men”), can both match a textual input “women”. The ranking of “women clothing” can be increased to indicate that it is more likely to be represented by the textual input, because “women clothing” includes the n-gram “women” that is identical to the textual input, and one or more operations are required to transform, e.g., transliterate, “ [symbol] ” into “women”.

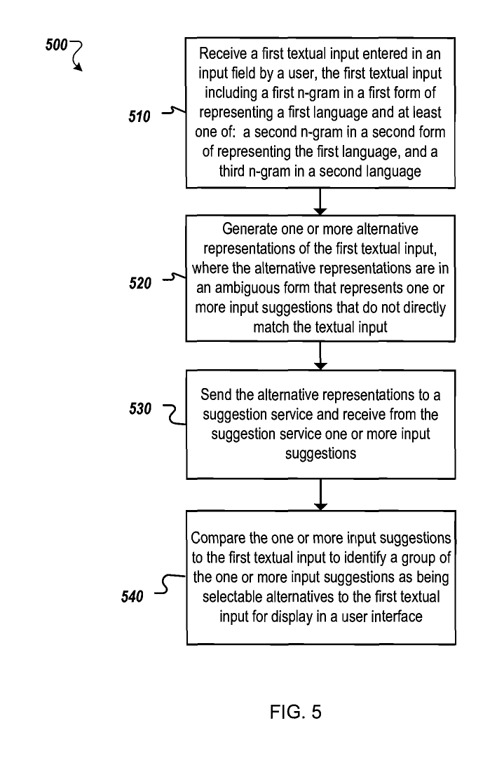

FIG. 5 is a flow chart showing an example process 500 for automatically generating selectable alternatives of textual input in different forms. The process 500 includes receiving 510 a first textual input entered in an input field by a user. The first textual input includes a first n-gram in a first form of representing a first language and at least one of: a second n-gram in a second form of representing the first language, and a third n-gram in a second language. The process 500 also includes generating 520 one or more alternative representations of the first textual input, where the alternative representations are in an ambiguous form that represents one or more input suggestions that do not directly match the textual input. The process 500 also includes sending 530 the alternative representations to a suggestion service and receiving from the suggestion service one or more input suggestions. The process 500 also includes comparing 540 the one or more input suggestions to the first textual input to identify a group of the one or more input suggestions as being selectable alternatives to the first textual input for display in a user interface.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a textual input entered in an input field by a user, the textual input including a first n-gram in a first form of representing a first language and at least one of:
a second n-gram in a second form of representing the first language; and
a third n-gram in a second language;
generating one or more alternative representations of the textual input, where the alternative representations are in an ambiguous form that represents one or more input suggestions that do not directly match the textual input;
sending the alternative representations to a suggestion service and receiving from the suggestion service one or more input suggestions; and
comparing the one or more input suggestions to the textual input to identify a group of the one or more input suggestions as being selectable alternatives to the textual input for display in a user interface.

2. The method of claim 1, where generating one or more alternative representations of the textual input in an ambiguous form includes:
segmenting the textual input into one or more contiguous sequences of characters, where each sequence represents a word or query;
identifying one or more representations of each segment, where each representation is in an alternative form; and
replacing, in the textual input, one or more segments with an associated representation in an alternative form to produce an alternative representation of the textual input.

3. The method of claim 1, where the textual input includes a second n-gram in a second form of representing the first language, and generating one or more alternative representations of the textual input in the ambiguous form includes:
generating a fourth n-gram from the textual input, where the fourth n-gram is an alternative representation of the textual input and includes one or more sequences of text in the second form.

4. The method of claim 3, where the fourth n-gram includes one or more sequences of text in the first form.

5. The method of claim 4, where the second form of representing the first language includes representing the first language using complete phonetic representations or partial phonetic representations.

6. The method of claim 5, where the first language is Chinese, and the first form of representing Chinese includes representing Chinese using Hanzi characters.

7. The method of claim 6, where:
a complete phonetic representation is a Pinyin syllable; and
a partial phonetic representation is a Pinyin abbreviation.

8. The method of claim 7, where the textual input includes a third n-gram in a second language and the second language is English.

9. The method of claim 8, where the selectable alternatives include one or more input suggestions that are represented using Hanzi characters.

10. The method of claim 1, where the textual input is received before the user submits the textual input in a request for a search and after waiting a predetermined amount of time after receiving each token of the textual input.

11. A system comprising:
a server comprising a computer;
where the server is operable to perform the actions of:
receiving a textual input entered in an input field by a user, the textual input including a first n-gram in a first form of representing a first language and at least one of:
a second n-gram in a second form of representing the first language; and
a third n-gram in a second language;
generating one or more alternative representations of the textual input, where the alternative representations are in an ambiguous form that represents one or more input suggestions that do not directly match the textual input;
sending the alternative representations to a suggestion service and receiving from the suggestion service one or more input suggestions; and
comparing the one or more input suggestions to the textual input to identify a group of the one or more input suggestions as being selectable alternatives to the textual input for display in a user interface.

12. The system of claim 11, where generating one or more alternative representations of the textual input in an ambiguous form includes:
segmenting the textual input into one or more contiguous sequences of characters, where each sequence represents a word or query;
identifying one or more representations of each segment, where each representation is in an alternative form; and
replacing, in the textual input, one or more segments with an associated representation in an alternative form to produce an alternative representation of the textual input.

13. The system of claim 11, where the textual input includes a second n-gram in a second form of representing the first language, and generating one or more alternative representations of the textual input in the ambiguous form includes:
generating a fourth n-gram from the textual input, where the fourth n-gram is an alternative representation of the textual input and includes one or more sequences of text in the second form.

14. The system of claim 13, where the fourth n-gram includes one or more sequences of text in the first form.

15. The system of claim 14, where the second form of representing the first language includes representing the first language using complete phonetic representations or partial phonetic representations.

16. The system of claim 15, where the first language is Chinese, and the first form of representing Chinese includes representing Chinese using Hanzi characters.

17. The system of claim 16, where:
a complete phonetic representation is a Pinyin syllable; and
a partial phonetic representation is a Pinyin abbreviation.

18. The system of claim 17, where the textual input includes a third n-gram in a second language and the second language is English.

19. The system of claim 18, where the selectable alternatives include one or more input suggestions that are represented using Hanzi characters.

20. The system of claim 11, where the textual input is received before the user submits the textual input in a request for a search and after waiting a predetermined amount of time after receiving each token of the textual input.

21. A computer program product, stored on a computer-readable medium, comprising instructions that when executed on a server cause the server to perform operations comprising:
receiving a textual input entered in an input field by a user, the textual input including a first n-gram in a first form of representing a first language and at least one of:
a second n-gram in a second form of representing the first language; and
a third n-gram in a second language;
generating one or more alternative representations of the textual input, where the alternative representations are in an ambiguous form that represents one or more input suggestions that do not directly match the textual input;
sending the alternative representations to a suggestion service and receiving from the suggestion service one or more input suggestions; and
comparing the one or more input suggestions to the textual input to identify a group of the one or more input suggestions as being selectable alternatives to the textual input for display in a user interface.
